(19) United States
(12) Patent Application Publication
(10) Pub. No.: US 2003/0084024 A1
(43) Pub. Date: May 1, 2003

(54) Integrated database system for an educational institution

(76) Inventors: Drake Christensen, Vernon Hills, IL (US); Ken Dauber, Stanford, CA (US); Patrick Ryan, North Barrington, IL (US); Lorilee Sadler, Riverwoods, IL (US)

Correspondence Address: BRINKS HOFER GILSON & LIONE, P.O. BOX 10395, CHICAGO, IL, 60611, US

(21) Appl. No.: 10/002,699

(22) Filed: Oct. 31, 2001

(51) Int. Cl. G06F 12/00; G06F 17/30

(52) U.S. Cl. 707/2; 707/205

(57) ABSTRACT

A method and system of integrating databases for an educational institution supports the transfer of data between multiple databases in an efficient and accurate manner. A first database is arranged to contain enrollment data in a first format. A second database is arranged to contain administrative data in a second format, which differs from the first format. The enrollment data is converted from the first format to the second format upon detection of a new enrollment of at least one student in a course. The converted enrollment data is transferred in the second format from the first database to the second database.

### FIELD OF THE INVENTION

This invention relates to an integrated database system for an educational institution, such as an on-line educational institution.

### BACKGROUND

An educational institution may use one or more databases to support the enrollment of students into electronic courses, the delivery of electronic courses to students, the billing of students for electronic courses, and the marketing of electronic courses to potential students. For example, a commercially available database product may provide an electronic-commerce platform that supports enrolling of students into an electronic course. However, the electronic-commerce platform may lack support for other back-office operations or administrative functions that are incident to the operation of an educational institution. Accordingly, if an educational institution seeks to have a comprehensive information technology solution that fully supports the operations of the educational institution, the educational institution may need to use multiple databases that are dedicated or limited in function.

In the prior art, the educational institution may select a group of commercially available databases that together are hoped to provide support for all of the desired operations of the educational institution. However, the different databases may not be able to exchange information readily or transparently because of different data storage formats, programming languages, and/or operating systems of the databases.

Various techniques have been adopted in an attempt to bridge the communications gap between disparate databases associated with a common entity, such as an educational institution. Under one technique, one or more clerical workers may repetitively enter similar or duplicative data into multiple databases via one or more user interfaces. Consequently, discrepancies between two databases may result if a clerical worker makes an error (e.g., typographical error) in one of the database entries. Further, if clerical workers are ill, on-strike, or otherwise absent, the entry of information into multiple databases may delay operations such as invoice processing and marketing activities or other business functions that are handled by more than one database. Thus, a need exists for facilitating communications between one or more databases to eliminate the need to manually enter data to into multiple databases.

Under another technique for facilitating communications between different databases, a file transfer process may be used to transfer data from one database to another. However, the transfer of the entire file may result in the transmission of duplicative information between the databases that does not require updating or the transmission of information in a batch after the lapse of considerable time. The transmission of duplicative or outdated information may place an undue burden on the processing resources or communication resources associated with the databases.

Thus, a need exists for managing the flow of information between multiple databases in an efficient way that increases the currency of the information and reduces the volume of data transferred.

### SUMMARY

In accordance with the invention, a method and system of integrating databases for an educational institution supports the transfer of data between multiple databases in an efficient and accurate manner. A first database is arranged to contain enrollment data in a first format. A second database is arranged to contain administrative data in a second format, which differs from the first format. The enrollment data is converted from the first format to the second format upon detection of a new enrollment of at least one student in a course. The converted enrollment data is transferred in the second format from the first database to the second database.

In accordance with another aspect of the invention, administrative data is converted from the second format to the first format upon an occurrence of a triggering update of the second database. The converted administrative data is transferred in the first format from the second database to the first database.

### BRIEF DESCRIPTION OF THE DRAWINGS

FIG. 1 is a block diagram of an integrated database system in accordance with the invention.

FIG. 2 is a block diagram that shows the first database and the second database of FIG. 1 in greater detail.

FIG. 3 is a block diagram that illustrates an alternate embodiment in which the first database and the second database are located remotely from the data transfer interface and data processing system of an on-line educational institution in accordance with the invention.

FIG. 4 is a flowchart of a method of integrating multiple databases for an educational institution in accordance with the invention.

FIG. 5 is another embodiment of a method of integrating multiple databases for educational institution in accordance with the invention.

FIG. 6 is a flowchart of a method for enrolling a new student into an electronic course in accordance with the invention.

### DETAILED DESCRIPTION

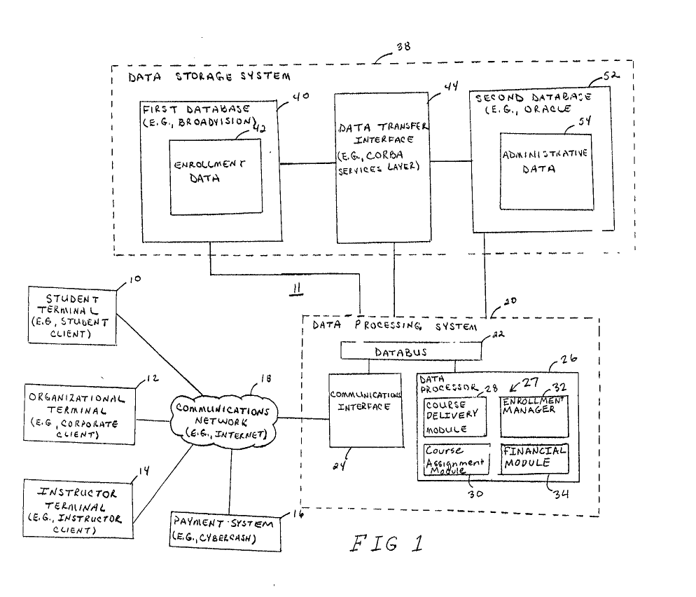

In accordance with the invention, FIG. 1 shows a block diagram of an integrated database system 11 for an educational institution (e.g., an on-line educational institution). The integrated database system 11 comprises a data storage system 38 in communication with a data processing system 20. The data processing system 20 may communicate with one or more of the following network elements via a communications network 18: a student terminal 10, an organizational terminal 12, an instructor terminal 14 and a payment system 16.

The data storage system 3 8 comprises a first database 40 that is coupled to a data transfer interface 44. In turn, the data transfer interface 44 is coupled to the second database 52. In one embodiment, the first database 40 supports storage and retrieval of enrollment data 42, whereas the second database 52 supports storage and retrieval of administrative data 54.

The enrollment data 42 may support electronic commerce activities between at least one student terminal 10 and the educational institution. For example, enrollment data 42 refers to any data (e.g., transactional data) that supports enrollment of one or more students into an electronic course by an electronic commerce transaction via at least one student terminal 10. The enrollment data 42 may refer to data for establishing a relationship between a student and the educational institution. In one embodiment, the enrollment data 42 includes a list of courses that are available for a potential student based upon the potential student's qualifications.

In another embodiment, the enrollment data 42 may include course availability data, student availability data, credit authorization data, and an enrollment history of a student and other electronic courses or the same electronic courses.

In yet another embodiment, the enrollment data 42 may comprise an agreement such as a legal agreement that defines a legal relationship between the student and the instructor. The agreement may restrict the student use of materials received in the electronic course, such as the right of the student to distribute the materials in the electronic course to third parties. The agreement may also include various limitations on the student's authorized use of copyrights and other intellectual property of the on-line educational institution.

Administrative data 54 refers to any data that supports provision of an electronic course to a student or other operations of the educational institution. Other operations of the educational institution may include back-office operations, billing, and marketing. The administrative data 54 of the second database 52 may include one or more of the following: customer record of a student, order creation for course delivery of a student, an invoice or bill generated for a student, sales and marketing data associated with the student, and instructor course assignments associated with the student. The enrollment data 42 and the administrative data 54 may include data components that overlap in content or data components that are exchanged between the first database 40 and the second database 52 to keep the databases (40, 52) up to date.

In one embodiment the first database 40 provides electronic commerce functionality for the on-line educational institution. The second database 52 may provide a comprehensive suite of back-office functions for the on-line educational institution. For example, the first database 40 may comprise a BroadVision database for e-commerce functionality and the second database 52 may comprise an Oracle database for back-office operations. BroadVision is a trademark of Broad Vision, Incorporated of Redwood City, Calif. Oracle is a trademark of Oracle Corporation of Redwood City, Calif.

The data transfer interface 44 may monitor one or more applications 27 to determine an appropriate time to update the second database 52 with data from the first database 40, or vice versa. To support the BroadVision database and the Oracle database, the data transfer interface 44 may comprise a CORBA services layer. CORBA refers to common object request broker architecture. The CORBA services layer supports communications between the BroadVision database and the Oracle database.

The data processing system 20 may comprise a data processor 26 and a communications interface 24 that are coupled to a databus 22. The data processor 26 may include one or more of the following applications 27: a course delivery module 28, an enrollment manager 32, a course assignment module 30, and a financial module 34. Each of the applications 27 may use data that is stored in the first database 40, the second database 52, or both. The communications interface 24 of the data processing system 20 supports communications between the data processing system 20 and one or more of the following: a student terminal 10, an organizational terminal 12, an instructor terminal 14, and a payment terminal.

The communications network 18 may comprise at least one of the Internet, a data packet network, a virtual link, a physical link, a virtual private network, and a circuit-switched communications network. For example the communications network 18 may include a public switched telephone network (PSTN) that is coupled to the Internet via an Internet Service Provider (ISP). In one embodiment, the data processing system 20 may comprise a server and the student terminal 10 may comprise a student client. The enrollment manager 32 facilitates the enrollment transaction of a student in an electronic course.

The course delivery module 28 facilitates delivery of an electronic course to a student terminal 10 via the communications network 18. The course assignment module 30 facilitates an assignment or pairing of at least one student to a corresponding electronic course. The course delivery module facilitates the transmission of an electronic course or portions thereof to at least one student terminal 10 via a communications network 18. The financial module 34 supports financial record-keeping and the billing operations of the educational institution with respect to one or more students of electronic courses.

The student terminal 10 may present an electronic course or a constituent component thereof to a student. A constituent component of a course may include a presentation, an audio visual presentation, visual data, audio data, a lecture, a multimedia presentation or otherwise. Further, the student terminal 10 may support interaction of the student terminal 10 with an instructor terminal 14. The instructor terminal 14 may refer to a client terminal that is adapted to provide guidance, feedback, or other communications to one or more student terminals 10. The organizational terminal 12 may observe or eavesdrop on the instructor-student interaction. In one embodiment, the organizational terminal 12 supports operations and maintenance of the data processing system 20 and the data storage system 38.

The payment system 16 may refer to a credit authorization service, such as Cyber Cash or another computer system for verifying the credit of a student or potential student of an electronic course.

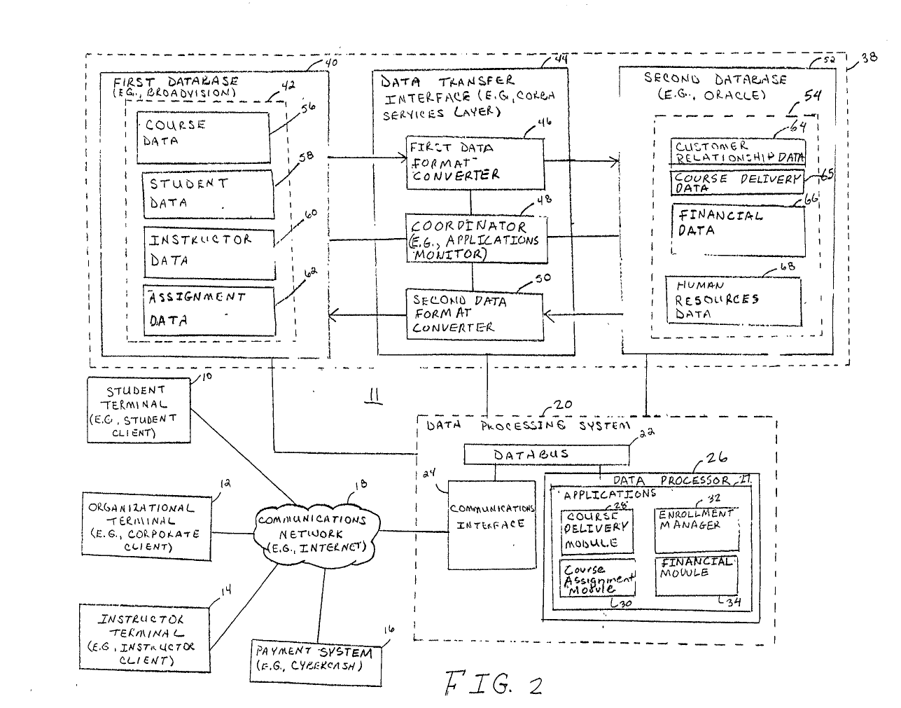

FIG. 2 shows illustrative compositions of the enrollment data 42 and administrative data 54 of FIG. 1. The enrollment data 42 may include one or more of the following: course data 56, student data 58, instructor data 60 and assignment data 62. The administrative data may include one or more of the following: customer relationship data 64, course delivery data 65, billing information data 66, and human resources data 68.

Course data 56 refers to any data associated with an electronic course or a proposed electronic course. In one embodiment, course data 56 may include any of the following items: a course identifier, a description of a course, a list of courses, a course schedule, or availability of courses. Student data 58 refers to any data associated with a student, a potential student, or a previous student of an electronic course. In one embodiment, student data 58 may include any of the following items: a student identifier, a student profile, student availability, student qualifications, student credit data, student e-mail address, student geographical address, student contact information, and student financial data. Instructor data 60 comprises one or more of the following types of data: an instructor identifier, an instructor profile, instructor qualifications, instructor availability, and a list of courses the instructor is qualified to teach. Assignment data 62 refers to the assignment of at least one student to a corresponding electronic course or a section of an electronic course for a defined time interval.

Customer relationship data 64 may comprise one or more of the following items: marketing data on at least one previous student, current student or prospective student; previous course identifiers or subject matter of courses in which a respective student enrolled; e-mail addresses or communications addresses of at least one previous student, current student or prospective student; and contact information or mailing address of at least one previous student, current student or prospective student.

Course delivery data 65 may comprise one or more of the following:

presentational materials, an audio presentation, a visual presentation, an audio-visual presentation, a multi-media presentation, a demonstration, and a lecture. Financial data 66 may comprise one or more of the following: a status of student payments, a credit history of a corresponding student, a financial history of a corresponding student, and student financial information. Human resources data 68 may comprise one or more of the following: a review of a respective instructor, an instructor profile, and instructor pay or salary information.

In one embodiment, the enrollment manager 32 determines whether to enroll at least one prospective student in an electronic course based on student data 58, financial data 66, or both. Further, the coordinator 48 detects the new enrollment after the enrollment manager determines compliance of at least one of the student data 58 and financial data 66 with a requirement of the educational institution. The financial module 34 may support the operation of the enrollment manager 32. For example, the financial module 34 may determine whether financial data 66 or received financial information of the prospective student complies with a requirement of the educational institution. The financial module 34 may communicate its determination of compliance or noncompliance for a particular prospective student's enrollment request to the enrollment manager 32. Further, the coordinator 48 detects the new enrollment after the enrollment manager 32 receives the financial module's determination or verifies the financial data 66 of the prospective student.

The enrollment data 42 of the first database 40 may support the generation of a document (e.g., a hypertext mark-up language document) or a web page for display on a student terminal 10 that allows the student or potential student to select an electronic course. In one embodiment the student may select or request a particular electronic course based upon course data 56 (e.g., a course identifier or a course title) presented via the student terminal 10.

Upon receipt of the student's request, the financial module 34 may check on financial data of the student seeking to enroll in an electronic course. For example, the financial module 34 may facilitate accessing the payment system 16 via the communications network 18 to obtain a verification or an authorization associated with a credit account, a debit account, or another financial account of a student. The enrollment manager 32 may enroll the student in the selected course based upon any of the following factors: (1) the financial module's determining that the student is creditworthy or otherwise meets a financial criteria established by the educational institution; (2) the enrollment manager 32 determining that the student is qualified to take the course; and (3) the enrollment manager 32 determining that a section of the electronic course is available for the student.

The data processing system 20 may access the first database 40 to determine if a student is qualified to enroll in a corresponding course. For example, the enrollment manager 32 may access enrollment data 42 of the first database 40 to determine the creditworthiness of the student, the qualifications of the student, and the availability of a particular course for a corresponding student based upon the assignment of other students to the same particular electronic course. The data processing system 20 may access the first database 40, the second database 52, or both to assign an instructor and a student to an electronic course. For example, the data processing system 20 may access administrative data 54 (e.g., course management data) in the second database 52 to assign a particular student to a corresponding electronic course.

The data transfer interface 44 may comprise a first data format converter 46, a second data format converter 50, and a coordinator 48. The coordinator 48 interacts with one or more applications 27 of the data processor 26. In one embodiment, the coordinator 26 comprises an applications monitor that monitors one or more applications 28 and events (e.g., triggering events) associated with the applications 28. The coordinator 48 may trigger the first data format converter 46, the second data format converter 50, or both.

In one example, an event may comprise a new enrollment of a student into an electronic course of the educational institution. If the enrollment manager 32 completes enrolling a student in an electronic course, the enrollment manager 32 may create a new enrollment event flag as an event. Upon detection of the enrollment event flag, the coordinator 38 triggers an update of the second database 52 with converted enrollment data 42 from the first database 40 or enrollment data 42 entered pursuant to the foregoing enrollment of the student. Accordingly, the coordinator 48 may trigger the operation of the first data format converter 46 as an interface between the first database 40 and the second database 52. The first data format converter 46 allows the transfer of enrollment data 42, or constituent components thereof, between the first database 40 and the second database 52, although the first database 40 and the second database 52 may be supported by different programming languages, different software operating systems, different data structures for relational data storage, different levels of hierarchical support of the data structures, or other differences between the databases (40, 52). The converted enrollment data and the administrative data 54 may overlap in subject matter content of the underlying data, such that the transfer of converted enrollment data from the first database 40 to the second database 52 may be used to update previous information or outdated administrative data 54.

The coordinator 48 may trigger the operation of the second data format converter 50 upon the detection of a triggering event of at least one of the applications 27. For example, the triggering event may comprise an update or triggering update of the administrative data 54 in the second database 52. The administrative data 54 may be updated by a user of an organizational terminal 12 via the communications network 12 or otherwise. The second data format converter 50 supports the transfer of converted administrative data from the second database 52 to the first database 40. The converted administrative data and the enrollment data 42 may overlap in subject matter content of the underlying data, such that the transfer of converted administrative data from the second database 52 to the first database 40 may be used to update previous information or outdated enrollment data 42.

The triggering update may be defined with respect to data (e.g., administrative data 54) that is updated in the data storage system 38 (e.g., the second database 52). In one example, the triggering update comprises the assignment of at least one of a student and an instructor to an electronic course. In another example, the triggering update comprises receiving at least one of updated student information and updated instructor information.

In one embodiment the first database 40 and the second database 52 both comprise relational databases. A relational database contains data in one or more related tables. A table arranges data in rows and columns. The first data format of the first database 40 may support a first set of hierarchical relationships between data entries. The second database 52 may support a second set of hierarchical relationships among data entries. The first set of hierarchical relationships may differ from the second set of hierarchical relationships. For example, the second set may support multi-level hierarchical relationships, whereas the first set does not.

In another embodiment, the first format and the second format may differ in the queries supported. For example, the second format of the second database 52 may support the queries in the form of structure query language (SQL). SQL supports distributed databases in which databases are distributed over different sites of a computer network.

The data transfer interface 44 may comprise a CORBA services layer. CORBA refers to common object request broker architecture. An object refers to a data entity that includes underlying data and associated procedures for manipulation of the underlined data. CORBA supports communications between different data entries or objects, where the objects may be written consistent with different programming languages and may be operating on different operating systems. For example, objects associated with the first database 40 and the second database 52 may be consistent with different programming languages. Similarly, objects associated with the first database 40 and the second database 52 may be written for different operating systems.

Object-oriented programming allows programmers to define relationships between objects such as hereditary relationships in which one object inherits characteristics of another object in a hierarchical fashion. Accordingly, the entries in the first database 40 and the second database 52 may be defined in terms of objects that differ from each other. The objects in the first database 40 and the second database 52 may be associated with CORBA interfaces.

In one embodiment, the first data format converter 46 and the second data format converter 50 may comprise one or more interfaces designed in accordance with OMG IDL. OMG refers to the object management group. An OMG IDL interface specifies an operation to be performed on a target object in the first database 40 and/or the second database 52. Further, the OMG IDL facilitates mapping of an IDL interface definition or instruction into one or more programming languages (e.g., C++ or Java). Java is an object-oriented programming language that was developed by Sun Microsystems and is similar to C++. Unix operating systems may support Java. C++ adds object-oriented features to the C language, which is high-level programming language.

The data transfer interface 44 may support IIOP, which refers to Internet inter-ORB protocol. IIOP is a protocol developed by the Object Management Group to implement CORBA solutions over the Internet. IIOP supports the exchange of data arrays and objects between clients and servers over a communications network 18. The first database 40 may comprise a first relational database as defined in one or more arrays arranged in a first data structure, whereas the second database 52 comprises a relational database having one or more arrays arranged in accordance with the second data structure.

In one embodiment the first database 40 refers to a BroadVision database that supports enrollment of student into an electronic course of the institution, validation of data associated with the student in the enrollment process, and credit or credit authorization associated with the student pursuant to the enrollment. In one embodiment, the second database 52 refers to an Oracle database that supports order fulfillment of an educational course such as delivery of an educational course, billing of an educational course, marketing of the course, customer relationship management of the course. The Oracle database may also support credit card transfers and settlement of funds with a payment system 16 via the communications network 18.

If a student profile is changed or added as customer relationship data 64 (e.g., marketing data) or a student data 58, the change may represent a triggering event for the coordinator 48 of the data transfer interface 44. The coordinator 48 may trigger the transfer of data between the first database 40 and the second database 52 to maintain consistency and accuracy between the data in the databases (40, 52). The first data converter may use standard application programming interfaces (API) and customized programming instructions to convert the data format between the first format to the second format for transfer between the databases (40,52). An API represents a building block of a program, such as a tool, a routine or another module, of a software application.

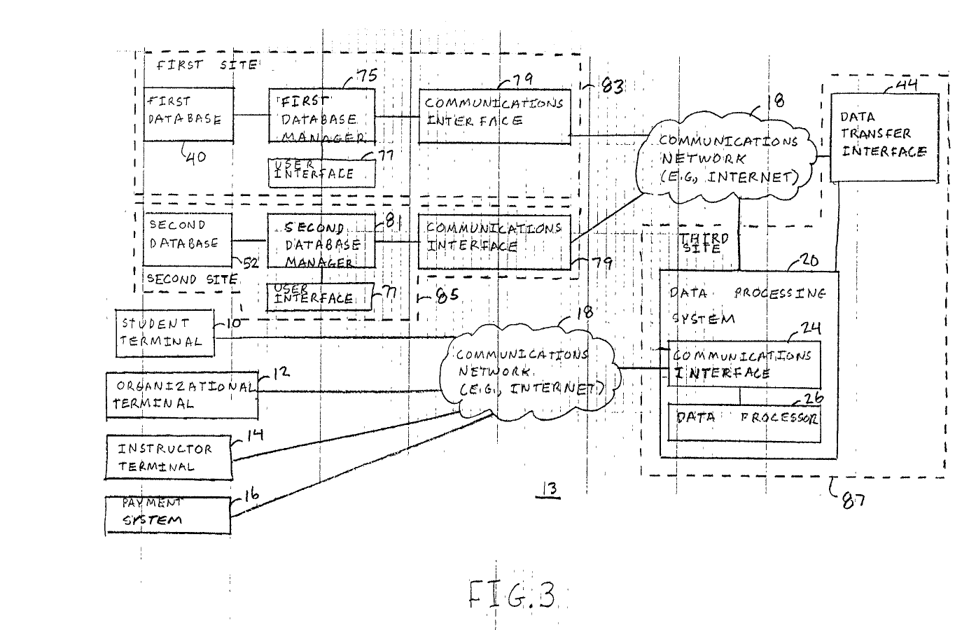

FIG. 3 is a block diagram of an alternate embodiment of an integrated database system 13 in which databases (40, 52) and the data transfer interface 44 are distributed across several sites (83, 85, 87). In contrast, the integrated database system 11 of FIG. 1 is not limited to any particular distribution of databases (40, 52) or the data transfer interface (44) among one or more sites. Like reference numbers in FIG. 1 and FIG. 3 indicate like elements.

In FIG. 3, the first database 40 is located at a first site 83 and the second database 52 is located at a second site 85. Further, the data transfer interface 44 and the data processing system 20 may be located at a third site 87, which is geographically separated from the first site 83 and the second site 85.

At the first site 83, the first database 40 is supported by a first database manager 75 and a communications interface 79 at the first site 83. In addition, the first database manager 75 may be associated with a user interface 77 to allow a user to enter inquiries or enter input data into the first database 40.

At the second site 85, the second database 52 is supported by a second database manager 81 and a communications interface 79 at the second site 85. The second database manager 81 may be associated with a user interface 77. The user interface 77 allows a user to enter queries or data into the second database 52.

The first site 83, the second site 85, and the third site 87 may be located in geographically distinct areas. For example, the first site 83 and the second site 85 may be located in different cities. The first database 40 and the second database 52 may exchange information by communications via the data transfer interface 44 and the communications network 18. The transfer of information between the first database 40 and a second database 52 may be under control of the data transfer interface 44, which detects a triggering event or a new enrollment associated with an application in the data processor 26 of the data processing system 20.

Advantageously, the configuration of FIG. 3 allows the first database 40 and the second database 52 to be maintained by a third party provider, distinct from the educational institution. For example, the first database 40 may be maintained by a provider that specializes in the maintenance of e-commerce databases and associated ecommerce services. Similarly, the second database 52 may be maintained by a second provider that maintains enterprise resource planning systems or business systems that support one or more business functions of an on-line educational institution. The third site 87 may be managed directly by the on-line institutional provider or outsourced in accordance with the objectives of the on-line institutional provider.

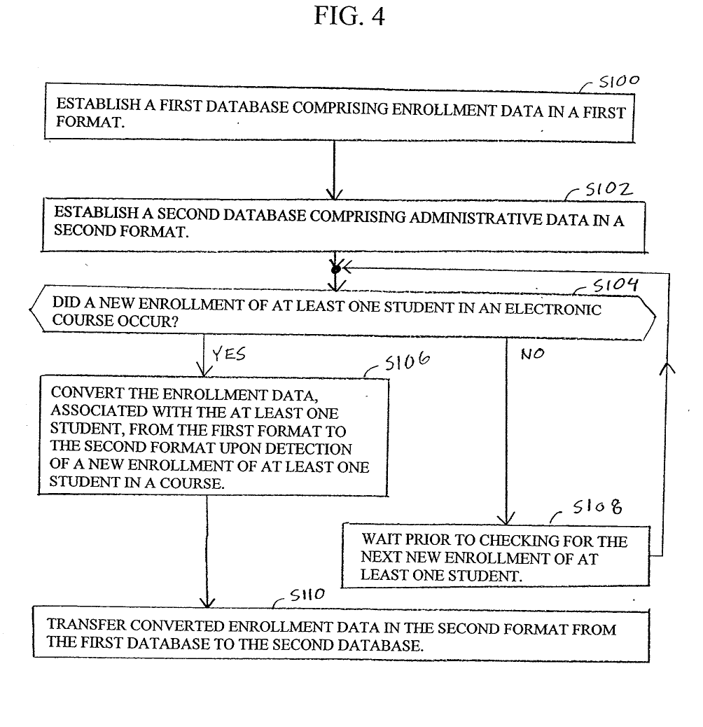

FIG. 4 is a flowchart of a method for providing an integrated database management system. The method of FIG. 4 starts in step S100.

In step S100, a first database 40 is maintained or established. The first database 40 may comprise enrollment data 42 that is stored in a first data format. In one embodiment, the first database manager 75 supports establishment or maintenance of the first database 40. The enrollment data 42 refers to any data that supports enrollment of a student in an electronic course along with any transaction associated with the establishment of a relationship for provision of the electronic course by the educational institution to the student.

In step S102, a second database 52 is established or maintained. The second database 52 may store administrative data 54 in a second data format. The administrative data 54 may comprise any data that supports one or more of the following functions: provision of an electronic course to an enrolled student, marketing of an electronic course to potential students, billing of electronic course services or other educational services to a student or former students, and other operational tasks associated with an educational institution.

In step S104, a data transfer interface 44 or a coordinator 48 determines if a new enrollment of at least one student in an electronic course occurred. If a new enrollment of at least one student in an electronic course occurred, th en the method continues with step S106. However, if a new enrollment of at least one student in an electronic course did not occur, then the method continues with step SI 08.

In step S106, a first format converter 46 or the data transfer interface 44 converts the enrollment data 42 from the first format to the second format upon detection of the new enrollment of at least one student in the course. The enrollment data 42 that is converted may be limited to the enrollment data 42 associated with the enrollment transaction of the at least one student in a particular electronic course. Accordingly, the transfer of information between the first database 40 and the second database 52 may be minimized by a transferring data that has changed in the first database 40 or is new to the first database 40.

In step S108, the data transfer interface 44 or the coordinator 48 waits prior to checking for the net new enrollment of at least one student. The coordinator 48 may be associated with a timer that is activated upon each execution of step S104 where the coordinator 48 did not detect a new enrollment of at least one student in an electronic course. After the expiration of the timer or waiting for a defined interval, the method continues with step S104.

Step S110 follows step S106. In step S110, the data transfer interface 44 supports the transfer of converted enrollment data 42 in the second format from the first database 40 to the second database 52. After the converted enrollment data 42 is transferred to the second database 52, the second database 52 may update one or more records or entries in the second database 52 consistent with the converted enrollment data 42. Accordingly, the first database 40 and the second database 52 are able to work in a coordinated manner in which the second database 52 reflects or contains the same or similar enrollment data 42 to the first database 40. With respect to FIG. 4, the converted enrollment data 42 may represent data that is in a set of overlapping data in the first database 40 and the second database 52.

In accordance with the method of FIG. 4, the updates to the second database 52 do not need to occur in a batch fashion in which multiple enrollment data 42 for multiple students have occurred. Likewise, the data in the first database 40 may be transferred to the second database 52 without human intervention to eliminate or reduce clerical entries that may subject the transfer to clerical errors. Moreover, the transfer of data from the first database 40 to the second database 52 does not require the transfer of duplicative information that would place an undue burden on the communications network 18 or processing resources of the integrated database system.

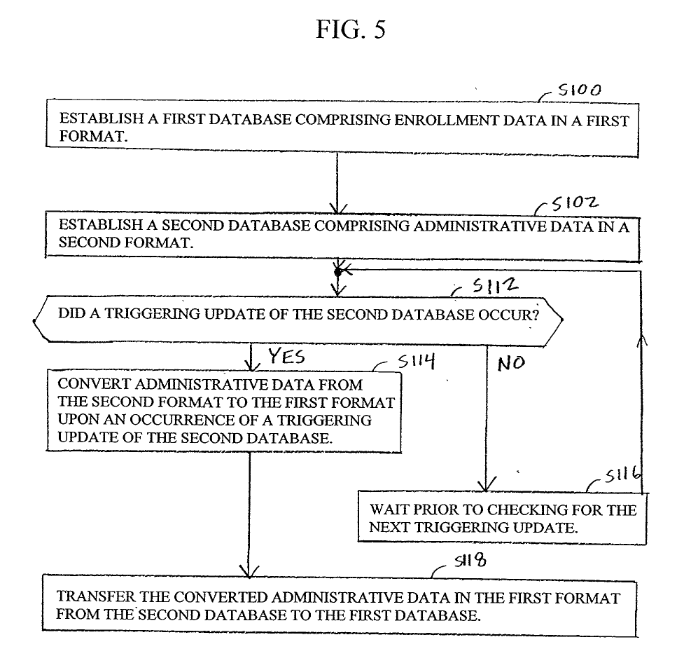

FIG. 5 is a flowchart of another method for management of an integrated database system. Like procedures or steps in FIG. 4 and FIG. 5 are indicated by like reference numbers.

In step S112, which may follow step S102 or step S100, the data transfer interface 44 or the coordinator 48 determines if a triggering update of the second database 52 occurred. If a triggering update of the second database 52 occurred, the method continues with step S114. However, if a triggering update of the database did not occur, then the method continues with step S116.

In step S114, the data transfer interface 44 or the second data format converter 50 converts administrative data 54 from the second format to the first format upon an occurrence of a triggering update of the second database 52. For example, a triggering update of the data in the second database 52 may comprise entering data via a user interface 77 that is associated with the second database 52. In another example, a triggering update may comprise an update to sales and marketing data in the second database 52.

In step S116, the data transfer interface 44 or the coordinator 48 wait prior to checking for the next triggering update. The data transfer interface 44 may be associated with a timer that is initiated upon determining that a triggering update of the second database 52 did not occur. Upon expiration of the timer, the method may continue from step S116 to step S112.

Step S118 follows step S114. In step S118, the data transfer interface 44 supports the transfer of the converted administrative data 54 in the first format from the second database 52 to the first database 40. The administrative data 54, or a derivative of the administrative data 54 stored in the first database 40, may be updated in accordance with the converted administrative data 54. The converted administrative data 54 may represent data that is in a set of overlapping data of the first database 40 and the second database 52.

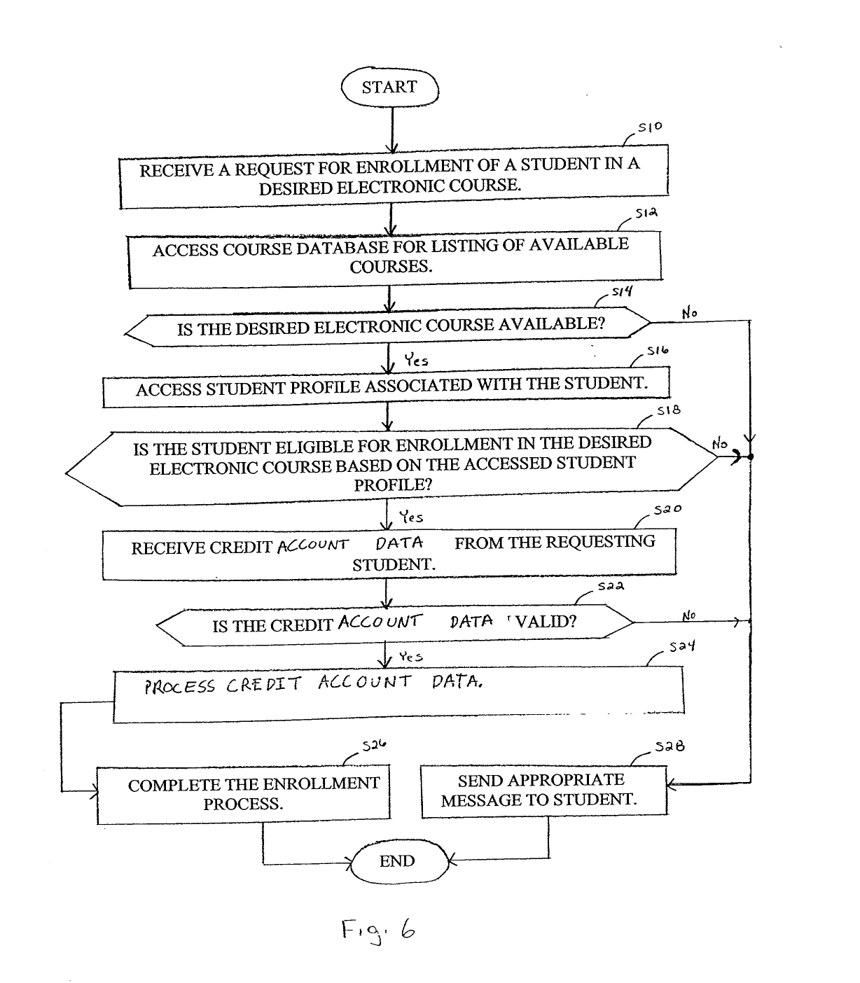

FIG. 6 represents a flowchart of a method for enrolling in an electronic course in accordance with the invention. The method of FIG. 6 starts in step S10.

In step S10, a data processing system 20 receives a request from a student terminal 10 or an organizational terminal 12 for enrollment of a student in a desired electronic course.

In step S12, the data processing system 20 may access the first database 40 for a listing of available courses. For example, the first database 40 may contain course data 56 that lists available courses by subject matter, course identifier, or otherwise.

In step S14, the data processor 26 determines if a selected or desired electronic course is currently available. If the desired electronic course is currently available for a corresponding student, then the method continues with step S16. However, if the electronic course is not available, then the method continues with step S28.

In step S16, the data processing system 20 accesses a student profile in the first database 40. The accessed student profile is associated with a student requesting enrollment in a desired course in the first database 40. The student profile may be used to determine whether or not the student is permitted to enroll in at least one desired electronic course.

In step S18, the data processing system 20 determines if the student is eligible for enrollment in the desired electronic course based in the accessed student profile. If the student is eligible for enrollment in the desired electronic course the method continues with step S20. However, if the student is not eligible for enrollment in the desired electronic course then the method continues with step S28. The student may be eligible for enrollment in the electronic course if the student meets in a certain educational course prerequisites or fulfills other characteristics designed by the educational institution, the teaching instructor, or both.

In step S20, the data processing system 20 may receive financial information (e.g., credit card information) from the requesting student via a student terminal 10 or an organizational terminal 12.

In step S22, the data processing system 20 determines if the financial information is valid and authenticates the credit information by checking the address of the student for example. If the financial information is valid and authenticated, then the method continues with step S24. If the credit card information is invalid or not able to be authenticated, then the method continues with step S28.

In step S24, the data processing system 20 processes the financial information. The data processing system 20 may communicate with a payment system 16 or credit bureau to execute step S22, step S24, or both.

Step S26 follows step S24 and step S26 entails completion of the enrollment process. Completion of the enrollment process comprises storing updated enrollment data 42 for at least one newly enrolled or registered student in the corresponding electronic course in the first database 40. For example, the enrollment manager or the data processing system 20 may store an enrollment event flag as a triggering event for the coordinator 48. The enrollment data 42 or the enrollment event flag for the newly enrolled student may provide a trigger for the coordinator 48 or the data transfer interface 44 as previously described herein. That trigger is used to update the second database 52 with data or data components from the first database 40.

In step S28, an appropriate message is sent to the student terminal 10 or the requesting terminal via the data processing system 20. The message sent in step S28 will depend upon the results of the decisions in step S14, S18, or step S22. In one example, if the data processing system 20 determines that the desired electronic course is not available in step S14, then the data processing system 20 may inform the student that the electronic course is not available in step S28. In another example, if the data processing system 20 determines that the student is not eligible for enrollment in the electronic course in step S18, the data processing system 20 may inform the student that the student does not meet an eligibility requirement or to contact a representative of the educational institution for assistance. In another example, the data processing system 20 determines that the credit information is not valid or authenticated, the data processing system 20 may inform that student that the credit information cannot be accepted at this time.

The foregoing description of the system and method describe several illustrated examples of the invention. Modifications, alternative arrangements, and variations of these illustrated examples are possible and may fall within the scope of the invention. Accordingly, the following claims should be accorded the reasonably broadest interpretation which is consistent with the specification disclosed herein and not unduly limited by aspects of the preferred embodiments disclosed herein.

The following is claimed:

1. A method of integrating databases for an educational institution, the method comprising:
establishing a first database comprising enrollment data in a first format;
establishing a second database comprising administrative data in a second format;
converting the enrollment data from the first format to the second format upon detection of a new enrollment of at least one student in a course; and
transferring converted enrollment data in the second format from the first database to the second database.

2. The method according to claim 1 wherein the detection of the new enrollment comprises:
verifying financial information on the enrollment of the at least one student.

3. The method according to claim 1 wherein the detection of the new enrollment comprises:
authorizing credit account data of the at least one student.

4. The method according to claim 1 wherein the transferring of converted enrollment data is transferred over a communications network from the first database to the second database.

5. The method according to claim 1 further comprising:
converting administrative data from the second format to the first format upon an occurrence of a triggering update of the second database; and
transferring the converted administrative data in the first format from the second database to the first database.

6. The method according to claim 5 wherein the transferring of converted administrative data is transferred over a communications network from the second database to the first database.

7. The method according to claim 5 wherein the triggering update comprises the assignment of at least one of a student and an instructor to an electronic course.

8. The method according to claim 5 wherein the triggering update comprises receiving at least one of updated student information and updated instructor information.

9. The method according to claim 1 wherein the method further comprises:
accessing the first database to determine if a student is qualified to enroll in a corresponding course.

10. The method according to claim 1 wherein the method further comprises accessing the second database to assign an instructor and a student to an electronic course.

11. The method according to claim 1 wherein the method further comprises delivering at least a portion of a content of the electronic course to an enrolled student.

12. An integrated database system for an educational institution, the system comprising:
a first database containing enrollment data in a first format;
a second database containing administrative data in a second format;
a first converter for converting the enrollment data from the first format to the second format upon detection of a new enrollment of at least one student in a course; and
a data transfer interface for transferring converted enrollment data in the second format from the first database to the second database.

13. The system according to claim 12 further comprising:
an enrollment manager for determining whether to enroll in the at least one student in an electronic course based on at least one of student data and financial data;
a coordinator for detecting the new enrollment after the enrollment manager determines compliance of at least one of the student data and financial data with a requirement of the educational institution.

14. The system according to claim 12 further comprising:
a financial module for determining whether received financial information of the student complies with a requirement of the educational institution;
a coordinator for detecting the new enrollment after the enrollment manager verifies the financial data of the at least one new student.

15. The system according to claim 12 further comprising:
a communications network arranged to transfer the converted enrollment data from the first database to the second database via the first converter.

16. The system according to claim 12 further comprising:
a second converter for converting administrative data from the second format to the first format upon an occurrence of a triggering update of the second database.

17. The system according to claim 16 wherein the data transfer interface is arranged to transfer the converted administrative data in the first format from the second database to the first database.

18. The system according to claim 16 further comprising:
a communications network arranged to transfer the converted administrative data from the second database to the first database via the second converter.

19. The system according to claim 16 wherein the triggering update comprises an assignment of at least one of a student and an instructor to an electronic course.

20. The system according to claim 16 wherein the triggering update comprises a receipt of at least one of updated student information and updated instructor information.

21. The system according to claim 12 wherein the system further comprises:
an enrollment module accessing the first database to determine if a student is qualified to enroll in a corresponding course.

22. The system according to claim 12 wherein the system further comprises:
a course assignment module for accessing the second database to assign an instructor and a student to an electronic course.

23. The system according to claim 12 wherein the system further comprises:
a course delivery module for delivering at least a portion of a content of the electronic course to an enrolled student.
